(19) United States
(12) Patent Application Publication
(10) Pub. No.: US 2015/0064337 A1
(43) Pub. Date: Mar. 5, 2015

(54) HEALTHY SUCROSE PRODUCT AND METHOD FOR FABRICATING THE SAME

(71) Applicant: Shandong Futaste Co.,Ltd, Qingdao (CN)

(72) Inventors: Qiang Tian, Qingdao (CN); Chengfu Wang, Qingdao (CN); Lu Sun, Qingdao (CN); Xisheng Jiang, Qingdao (CN); Xiaoning Qiao, Qingdao (CN); Ruifeng Du, Qingdao (CN); Weihong Huang, Qingdao (CN)

(73) Assignee: Shandong Futaste Co.,Ltd, Qingdao (CN)

(21) Appl. No.: 14/261,442

(22) Filed: Apr. 25, 2014

(30) Foreign Application Priority Data
Aug. 30, 2013 (CN) 2013103842030

(51) Int. Cl. A23L 1/236

(52) U.S. Cl. CPC A23L 1/2363; A23V 2002/00
USPC 426/658

(57) ABSTRACT

The invention discloses a healthy sucrose product and a method for fabricating the same. The sucrose product mainly consists of sucrose and L-arabinose, wherein sucrose has a mass percentage of 70-99.99%, and L-arabinose has a mass percentage of 0.01-30%. The method for fabricating the sucrose product mainly comprises the steps of: sufficiently mixing solid sucrose and L-arabinose crystals; or mixing solid sucrose and L-arabinose solution and then drying the resulting solution. In the present healthy sucrose product, L-arabinose is added into sucrose for suppressing invertase's activity, so that the human body's absorption of sucrose is reduced to achieve a healthy intake of sugar. In this manner, the problems of hyperglycemia, dental caries, and obesity, which otherwise may occur after the intake of sucrose, are solved.

### CROSS-REFERENCE TO RELATED APPLICATION

This application claims the priority benefit of Chinese patent application No.2013103842030, filed on Aug. 30, 2013. The entirety of the above-mentioned patent application is hereby incorporated by reference herein and made a part of specification.

### BACKGROUND OF THE INVENTION

1. Field of Invention

The present invention relates to the field of foods, and particularly to a healthy sucrose product containing L-arabinose and a method for fabricating the same.

2. Background of Invention

With the continuous development of productivity and the continuous improvement of people's living standards, incidence of obesity, fat disease, diabetes, and cardiovascular disease continues to increase, which seriously affects human's health and longevity. The rate of obesity even reaches 45-55% in some developed regions and 10-20% in developing countries, and exhibits a trend of further development and younger age. According to analysis, the main reason lies in excessive intake of sweet food and high-fat food. The sweet taste in the sweet food mainly comes from sucrose. Upon ingestion, sucrose can be decomposed into fructose and glucose, thus increasing the level of blood glucose in the body. The excessive sucrose turns into body fat and is stored in the body, which causes obesity. Thus, there is a urgent request for a healthy sucrose. The Chinese Patent No. 200910229364.6 entitled “Novel functional healthy sugar and preparation process thereof” discloses a healthy sugar product in which sucrose and arabinose are mixed by a mass ratio of 2-98:98-2. This healthy sugar product is fabricated by melting and crystallization. The method for fabricating comprises the steps of dissolving, concentrating under vacuum, crystallizing, grinding or the like. The production process is complicated. The grain size of after grinding is difficult to control, and the state of sucrose is changed. Now, there is a request for a healthy sugar product which is simple and feasible in term of its fabricating process, can reduce or completely suppress the absorption of sucrose, and does not change sweetness and grain state of sucrose. This is not only a hot topic of researchers, but also a gospel for people who like sugar and people who suffer from high cholesterol, high blood pressure, and high blood glucose.

### BRIEF SUMMARY OF THE INVENTION

In order to solve the above technical problems, the present invention discloses a healthy sucrose product.

The sucrose product of the present invention mainly consists of sucrose and L-arabinose, wherein sucrose has a mass percentage of 70-99.99%, and L-arabinose has a mass percentage of 0.01-30%.

According to the present invention, sucrose comprises but is not limited to, raw sugar, white granulated sugar, soft white sugar, brown granulated sugar, golden granulated sugar, brown sugar powder, white granulated sugar powder, and crystal sugar powder.

According to the present invention, a method for fabricating the sucrose product mainly comprises the steps of: sufficiently mixing solid sucrose and L-arabinose crystals; or mixing solid sucrose and L-arabinose solution and then drying the resulting solution.

Preferably, sucrose and L-arabinose are mixed in such a manner that solid sucrose is mixed with L-arabinose solution, and the L-arabinose solution is sprayed onto solid sucrose.

According to the present invention, the L-arabinose solution is a L-arabinose concentrated solution, L-arabinose mother liquor, or a solution prepared from L-arabinose crystals.

According to an embodiment of the present invention, the solution prepared from L-arabinose crystals has a mass concentration of 15-50%.

According to another embodiment of the present invention, the L-arabinose concentrated solution has a mass concentration of 35-50%, with dry material in which the L-arabinose has a mass content of 55-85%.

The L-arabinose concentrated solution is a solution which is obtained by concentrating a L-arabinose containing solution, and is a solution for preparing L-arabinose crystals prior to crystallization.

According to a further embodiment of the present invention, the L-arabinose mother liquor has a mass concentration of 40-55%, with dry material in which L-arabinose has a mass content of 30-65%.

The L-arabinose mother liquor is a solution which is obtained after the L-arabinose solution is crystallized and centrifuged during preparing L-arabinose crystals, and is a solution which is obtained after L-arabinose has crystallized for one or more times and which still contains L-arabinose.

According to the present invention, the L-arabinose concentrated solution or L-arabinose mother liquor is subject to or not subject to decoloration treatment with activated carbon, and then is sprayed onto sucrose crystals; wherein if the L-arabinose concentrated solution or L-arabinose mother liquor has a transmittance not larger than 99%, it is required to be subject to a decoloration treatment with activated carbon.

The decoloration treatment is performed at a decoloration temperature of 60-90° C. and a decoloration duration of 30-60 min.

According to the present invention, the drying is performed by placing the mixed sucrose and L-arabinose in a blast drying cabinet for drying, wherein the drying temperature is controlled at 30-80° C. and the drying duration is 10-60 min.

The present invention further discloses a method for fabricating the sucrose product.

According to the present invention, a method for fabricating the sucrose product mainly comprises the steps of: sufficiently mixing solid sucrose and L-arabinose crystals; or mixing solid sucrose and L-arabinose solution and then drying the resulting solution.

Preferably, sucrose and L-arabinose are mixed in such a manner that solid sucrose is mixed with L-arabinose solution, and the L-arabinose solution is sprayed onto solid sucrose.

According to the present invention, the L-arabinose solution is a L-arabinose concentrated solution, L-arabinose mother liquor, or a solution prepared from L-arabinose crystals.

According to one of embodiments of the present invention, the solution prepared from L-arabinose crystals has a mass concentration of 15-50%.

According to another embodiment of the present invention, the L-arabinose concentrated solution has a mass concentration of 35-50%, with dry material in which the L-arabinose has a mass content of 55-85%.

The L-arabinose concentrated solution is a solution which is obtained by concentrating a L-arabinose containing solution, and is a solution for preparing L-arabinose crystals prior to crystallization.

According to a further embodiment of the present invention, the L-arabinose mother liquor has a mass concentration of 40-55%, with dry material in which L-arabinose has a mass content of 30-65%.

The L-arabinose mother liquor is a solution which is obtained after the L-arabinose solution is crystallized and centrifuged during preparing L-arabinose crystals, and is a solution which is obtained after L-arabinose has crystallized for one or more times and which still contains L-arabinose.

According to the present invention, the L-arabinose concentrated solution or L-arabinose mother liquor is subject to or not subject to decoloration treatment with activated carbon, and then is sprayed onto sucrose crystals; wherein if the L-arabinose concentrated solution or L-arabinose mother liquor has a transmittance not larger than 99%, it is required to be subject to a decoloration treatment with activated carbon.

The decoloration treatment is performed at a decoloration temperature of 60-90° C. and a decoloration duration of 30-60 min.

According to the present invention, the drying is performed by placing the mixed sucrose and L-arabinose in a blast drying cabinet for drying, wherein the drying temperature is controlled at 30-80° C. and the drying duration is 10-60 min.

The present invention discloses a healthy sucrose product and a method for fabricating the same. L-arabinose is added into sucrose for suppressing invertase's activity, so that the human body's absorption of sucrose is reduced to achieve a healthy intake of sugar. In this manner, the problems of hyperglycemia, dental caries, and obesity, which otherwise may occur after the intake of sucrose, are solved.

### DETAILED DESCRIPTION OF THE EMBODIMENTS

### Embodiment 1

L-arabinose crystals of a certain amount are placed in a beaker, and pure water with a certain amount is added, thus forming a L-arabinose solution with a concentration of 45%.

Sucrose with a mass of 97 g is weighted with an electronic balance. Sucrose is placed in a vibration plate and is spread evenly. The vibration plate is started and can operate up to such a power that sucrose does not fall from the vibration plate. The above 45% L-arabinose crystals solution with a mass of 6.7 g is further weighted with an electronic balance, and is added to a spraying bottle. By using the spraying bottle, the L-arabinose solution is uniformly sprayed onto sucrose. The vibration duration is controlled at 30 min.

The sample which has been vibrated uniformly is placed in a blast drying cabinet for drying, with a drying temperature of 45° C. and a drying duration of 20 min. A moisture content of the dried sample is measured. The sample with a mass of 10.0239 g is weighted with a precision electronic balance, and then the sample is placed in a vacuum drying cabinet. The vacuum degree is controlled at −0.07 MPa, and the drying duration is 60 min. The dried sample is weighted with a precision electronic balance and has a mass of 9.8872 g, indicating that the dried sample has a moisture content of 1.36%. Here, L-arabinose has a mass content of 2.89%, and sucrose has a mass content of 96.37%.

### Embodiment 2

L-arabinose crystals of a certain amount are placed in a beaker, and pure water with a certain amount is added, thus forming a L-arabinose solution with a concentration of 45%.

Sucrose with a mass of 90 g is weighted with an electronic balance. Sucrose is placed in a vibration plate and is spread evenly. The vibration plate is started and can operate up to such a power that sucrose does not fall from the vibration plate. The above 45% L-arabinose crystals solution with a mass of 22 g is further weighted with an electronic balance, and is added into a spraying bottle. By using the spraying bottle, the L-arabinose solution is uniformly sprayed onto sucrose. The vibration duration is controlled at 10 min.

The sample which has been vibrated uniformly is placed in a blast drying cabinet for drying, with a drying temperature of 45° C. and a drying duration of 40 min. A moisture content of the dried sample is measured. The sample with a mass of 10.0157 g is weighted with a precision electronic balance, and then the sample is placed in a vacuum drying cabinet. The vacuum degree is controlled at −0.07 MPa, and the drying duration is 60 min. The dried sample is weighted with a precision electronic balance and has a mass of 9.9272 g, indicating that the dried sample has a moisture content of 0.88%. Here, L-arabinose has a mass content of 9.75%, and sucrose has a mass content of 89.57%.

### Embodiment 3

A L-arabinose mother liquor with a concentration of 54% and a purity of 64.7%, in which L-arabinose has crystallized and has been centrifuged, is placed in a beaker. Activated carbon is added for decoloration by an amount of 5% of the dry material in the L-arabinose mother liquor. The decoloration temperature is 75° C., and the decoloration duration is 30 min. The L-arabinose mother liquor is then subject to filtration under vacuum. After decoloration and filtration, the L-arabinose mother liquor has a transmittance of 99%.

Soft white sugar with a mass of 95 g is weighted with an electronic balance. Soft white sugar is placed in a vibration plate and is spread evenly. The vibration plate is started and can operate up to such a power that soft white sugar does not fall from the vibration plate. L-arabinose mother liquor with a mass of 8.28 g is further weighted with an electronic balance, and is added into a spraying bottle. By using the spraying bottle, the L-arabinose mother liquor is uniformly sprayed onto soft white sugar. The vibration duration is controlled at 20 min.

The sample which has been vibrated uniformly is placed in a blast drying cabinet for drying, with a drying temperature of 40° C. and a drying duration of 15 min. A moisture content of the dried sample is measured. The sample with a mass of 9.9938 g is weighted with a precision electronic balance, and then the sample is placed in a vacuum drying cabinet. The vacuum degree is controlled at −0.07 MPa, and the drying duration is 60 min. The dried sample is weighted with a precision electronic balance and has a mass of 9.8702 g, indicating that the dried sample has a moisture content of 1.24%. Here, L-arabinose has a mass content of 4.22%, and sucrose has a mass content of 94.37%.

### Embodiment 4

A L-arabinose mother liquor with a concentration of 54% and a purity of 64.7%, in which L-arabinose has crystallized and has been centrifuged, is placed in a beaker. Activated carbon is added for decoloration by an amount of 5% of the dry material in the L-arabinose mother liquor. The decoloration temperature is 75° C., and the decoloration duration is 30 min. The L-arabinose mother liquor is then subject to filtration under vacuum. After decoloration and filtration, the L-arabinose mother liquor has a transmittance of 100%.

Sucrose with a mass of 90 g is weighted with an electronic balance. Sucrose is placed in a vibration plate and is spread evenly. The vibration plate is started and can operate up to such a power that sucrose does not fall from the vibration plate. L-arabinose mother liquor with a mass of 29 g is further weighted with an electronic balance, and is added into a spraying bottle. By using the spraying bottle, the L-arabinose mother liquor is uniformly sprayed onto sucrose. The vibration duration is controlled at 20 min.

The sample which has been vibrated uniformly is placed in a blast drying cabinet for drying, with a drying temperature of 40° C. and a drying duration of 15 min. A moisture content of the dried sample is measured. The sample with a mass of 9.9898 g is weighted with a precision electronic balance, and then the sample is placed in a vacuum drying cabinet. The vacuum degree is controlled at −0.07 MPa, and the drying duration is 60 min. The dried sample is weighted with a precision electronic balance and has a mass of 9.7912 g, indicating that the dried sample has a moisture content of 1.9%. Here, L-arabinose has a mass content of 9.72%, and sucrose has a mass content of 88.27%.

### Embodiment 5

A concentrated solution of L-arabinose with a concentration of 48% and a purity of 81.6%, in which L-arabinose has not crystallized, is placed in a beaker. Activated carbon is added for decoloration by an amount of 7% of the dry material in the L-arabinose concentrated solution. The decoloration temperature is 80° C., and the decoloration duration is 30 min. The L-arabinose concentrated solution is then subject to filtration under vacuum. After decoloration and filtration, the L-arabinose concentrated solution has a transmittance of 100%.

Sucrose with a mass of 95 g is weighted with an electronic balance. Sucrose is placed in a vibration plate and is spread evenly. The vibration plate is started and can operate up to such a power that sucrose does not fall from the vibration plate. L-arabinose concentrated solution with a mass of 8.16 g is further weighted with an electronic balance, and is added into a spraying bottle. By using the spraying bottle, the L-arabinose concentrated solution is uniformly sprayed onto sucrose. The vibration duration is controlled at 25 min.

The sample which has been vibrated uniformly is placed in a blast drying cabinet for drying, with a drying temperature of 40° C. and a drying duration of 35 min. A moisture content of the dried sample is measured. The sample with a mass of 9.9989 g is weighted with a precision electronic balance, and then the sample is placed in a vacuum drying cabinet. The vacuum degree is controlled at −0.07 MPa, and the drying duration is 60 min. The dried sample is weighted with a precision electronic balance and has a mass of 9.8102 g, indicating that the dried sample has a moisture content of 1.88%. Here, L-arabinose has a mass content of 3.8%, and sucrose has a mass content of 95.3%.

### Embodiment 6

A concentrated solution of L-arabinose with a concentration of 48% and a purity of 81.6%, in which L-arabinose has not crystallized, is placed in a beaker. Activated carbon is added for decoloration by an amount of 7% of the dry material in the L-arabinose concentrated solution. The decoloration temperature is 80° C., and the decoloration duration is 30 min. The L-arabinose concentrated solution is then subject to filtration under vacuum. After decoloration and filtration, the L-arabinose concentrated solution has a transmittance of 100%.

Sucrose with a mass of 90 g is weighted with an electronic balance. Sucrose is placed in a vibration plate and is spread evenly. The vibration plate is started and can operate up to such a power that sucrose does not fall from the vibration plate. L-arabinose concentrated solution with a mass of 26 g is further weighted with an electronic balance, and is added into a spraying bottle. By using the spraying bottle, the L-arabinose concentrated solution is uniformly sprayed onto sucrose. The vibration duration is controlled at 25 min.

The sample which has been vibrated uniformly is placed in a blast drying cabinet for drying, with a drying temperature of 40° C. and a drying duration of 35 min. A moisture content of the dried sample is measured. The sample with a mass of 10.0154 g is weighted with a precision electronic balance, and then the sample is placed in a vacuum drying cabinet. The vacuum degree is controlled at −0.07 MPa, and the drying duration is 60 min. The dried sample is weighted with a precision electronic balance and has a mass of 9.9152 g, indicating that the dried sample has a moisture content of 1.0%. Here, L-arabinose has a mass content of 9.13%, and sucrose has a mass content of 88.79%.

### Embodiment 7

Sucrose with a mass of 97 g is weighted with an electronic balance. Sucrose is placed in a vibration plate and is spread evenly. The vibration plate is started and can operate up to such a power that sucrose does not fall from the vibration plate. L-arabinose with a mass of 3 g is further weighted an electronic balance, and is added to sucrose. The vibration duration is controlled at 25 min. Once vibration is complete, the uniformity of the mixed sample and the content of each component of the mixed sample are measured. According to the measurement, L-arabinose has a mass content of 3.5%, and sucrose has a mass content of 96.5%.

### Embodiment 8

Sucrose with a mass of 90 g is weighted with an electronic balance. Sucrose is placed in a vibration plate and is spread evenly. The vibration plate is started and can operate up to such a power that sucrose does not fall from the vibration plate. L-arabinose with a mass of 10 g is further weighted with an electronic balance, and is added to sucrose. The vibration duration is controlled at 35 min. Once vibration is complete, the uniformity of the mixed sample and the content of each component of the mixed sample are measured. According to the measurement, L-arabinose has a mass content of 9.5%, and sucrose has a mass content of 89.5%.

1. A healthy sucrose product, characterized in that, the healthy sucrose product mainly consists of sucrose and L-arabinose, wherein sucrose has a mass percentage of 70-99.99%, and L-arabinose has a mass percentage of 0.01-30%.

2. The healthy sucrose product of claim 1, characterized in that, sucrose comprises but is not limited to, raw sugar, white granulated sugar, soft white sugar, brown granulated sugar, golden granulated sugar, brown sugar powder, white granulated sugar powder, and crystal sugar powder.

3. A method for fabricating the healthy sucrose product of claim 1, characterized by mainly comprising the steps of: sufficiently mixing solid sucrose and L-arabinose crystals; or mixing solid sucrose and L-arabinose solution and then drying the resulting solution.

4. The method of claim 3, characterized in that, sucrose and L-arabinose are mixed in such a manner that solid sucrose is mixed with L-arabinose solution, and the L-arabinose solution is sprayed onto solid sucrose.

5. The method of claim 3, characterized in that, the L-arabinose solution is a L-arabinose concentrated solution, L-arabinose mother liquor, or a solution prepared from L-arabinose crystals.

6. The method of claim 5, characterized in that, the solution prepared from L-arabinose crystals has a mass concentration of 15-50%; the L-arabinose concentrated solution has a mass concentration of 35-50%, with dry material in which the L-arabinose has a mass content of 55-85%; and the L-arabinose mother liquor has a mass concentration of 40-55%, with dry material in which the L-arabinose has a mass content of 30-65%.

7. The method of claim 4, characterized in that, the L-arabinose solution is a L-arabinose concentrated solution, L-arabinose mother liquor, or a solution prepared from L-arabinose crystals.

8. The method of claim 7, characterized in that, the solution prepared from L-arabinose crystals has a mass concentration of 15-50%; the L-arabinose concentrated solution has a mass concentration of 35-50%, with dry material in which the L-arabinose has a mass content of 55-85%; and the L-arabinose mother liquor has a mass concentration of 40-55%, with dry material in which the L-arabinose has a mass content of 30-65%.

9. The method of claim 5, characterized in that, the L-arabinose concentrated solution or L-arabinose mother liquor is subject to or not subject to decoloration treatment with activated carbon, and then is sprayed onto sucrose crystals; wherein if the L-arabinose concentrated solution or L-arabinose mother liquor has a transmittance not larger than 99%, it is required to be subject to a decoloration treatment with activated carbon.

10. The method of claim 7, characterized in that, the L-arabinose concentrated solution or L-arabinose mother liquor is subject to or not subject to decoloration treatment with activated carbon, and then is sprayed onto sucrose crystals; wherein if the L-arabinose concentrated solution or L-arabinose mother liquor has a transmittance not larger than 99%, it is required to be subject to a decoloration treatment with activated carbon.

11. The method of claim 9, characterized in that, the decoloration treatment is performed at a decoloration temperature of 60-90° C. and a decoloration duration of 30-60 min.

12. The method of claim 10, characterized in that, the decoloration treatment is performed at a decoloration temperature of 60-90° C. and a decoloration duration of 30-60 min.

13. The method of claim 3, characterized in that, the drying is performed by placing the mixed sucrose and L-arabinose in a blast drying cabinet for drying, wherein the drying temperature is controlled at 30-80° C. and the drying duration is 10-60 min.

14. A method for fabricating the healthy sucrose product of claim 2, characterized in that, mainly comprises the steps of: sufficiently mixing solid sucrose and L-arabinose crystals; or mixing solid sucrose and L-arabinose solution and then drying the resulting solution.

15. The method of claim 14, characterized in that, sucrose and L-arabinose are mixed in such a manner that solid sucrose is mixed with L-arabinose solution, and the L-arabinose solution is sprayed onto solid sucrose.

16. The method of claim 14, characterized in that, the L-arabinose solution is a L-arabinose concentrated solution, L-arabinose mother liquor, or a solution prepared from L-arabinose crystals.

17. The method of claim 16, characterized in that, the solution prepared from L-arabinose crystals has a mass concentration of 15-50%; the L-arabinose concentrated solution has a mass concentration of 35-50%, with dry material in which the L-arabinose has a mass content of 55-85%; and the L-arabinose mother liquor has a mass concentration of 40-55%, with dry material in which the L-arabinose has a mass content of 30-65%.

18. The method of claim 15, characterized in that, the L-arabinose solution is a L-arabinose concentrated solution, L-arabinose mother liquor, or a solution prepared from L-arabinose crystals.

19. The method of claim 18, characterized in that, the solution prepared from L-arabinose crystals has a mass concentration of 15-50%; the L-arabinose concentrated solution has a mass concentration of 35-50%, with dry material in which the L-arabinose has a mass content of 55-85%; and the L-arabinose mother liquor has a mass concentration of 40-55%, with dry material in which the L-arabinose has a mass content of 30-65%.

20. The method of claim 16, characterized in that, the L-arabinose concentrated solution or L-arabinose mother liquor is subject to or not subject to decoloration treatment with activated carbon, and then is sprayed onto sucrose crystals; wherein if the L-arabinose concentrated solution or L-arabinose mother liquor has a transmittance not larger than 99%, it is required to be subject to a decoloration treatment with activated carbon.
